(19) United States
(12) Patent Application Publication
(10) Pub. No.: US 2025/0350486 A1
(43) Pub. Date: Nov. 13, 2025

(54) SYSTEM AND METHOD FOR AUTHENTICATING PRESENCE IN A ROOM

(71) Applicant: CANON U.S.A., INC., MELVILLE, NY (US)

(72) Inventor: Shingo Murata, Mineola, NY (US)

(21) Appl. No.: 18/871,683

(22) PCT Filed: Jun. 6, 2023
(86) PCT No.: PCT/US2023/024563

§ 371 Date: Dec. 4, 2024

Related U.S. Application Data
(60) Provisional application No. 63/349,734, filed on Jun. 7, 2022.

(51) Int. Cl. H04L 12/18; G06F 3/01

(52) U.S. Cl. CPC H04L 12/1822; G06F 3/017

(57) ABSTRACT

A server is provided and comprises one or more processors; and one or more memories storing instructions that, when executed, configures the one or more processors, to receive a series of images including at least one user captured by an image capture apparatus and provide a user interface that enables initiation of an online meeting in response to detecting, in the received series of images, that one of the at least one users has performed a predetermined gesture indicative of the user being physically present in a particular space.

### CROSS-REFERENCE TO RELATED APPLICATIONS

This PCT Application claims priority from U.S. Provisional Patent Application Ser. No. 63/349,734 filed on Jun. 7, 2022, the entirety of which is incorporated herein by reference.

### BACKGROUND

### Field

The present disclosure relates generally to authentication used in bidirectional audio visual communication performed over a communication network.

### Description of Related Art

Online meetings between users is known including when a group of individuals at one location are communicating remotely with one or more individuals not presently located at the one location. In certain instances, during these meetings one or more users a first location are able to visually share information and/or objects that are present at the first location with one or more various users located remotely from the first location. Users at the first location may initiate an online meeting and that meeting may be associated with one or more aspects of the first location. Therefore, a drawback associated with this environment is that a user who is not actually present in the first location could begin an online meeting at the first location thereby obtain views of the first location that they may not be entitled to see.

### SUMMARY

A system and method according to the present disclosure remedies the drawbacks associated with current online meeting solutions to improve security by ensuring only users at a particular location can begin a meeting.

A server is provided and comprises one or more processors; and one or more memories storing instructions that, when executed, configures the one or more processors, to receive a series of images including at least one user captured by an image capture apparatus and provide a user interface that enables initiation of an online meeting in response to detecting, in the received series of images, that one of the at least one users has performed a predetermined gesture indicative of the user being physically present in a particular space.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is an illustrative view of an environment where an online meeting solution is deployed according to the present disclosure.

FIG. 2 is a block diagram of illustrating various applications that, when executed, perform certain functions in an online meeting solution according to the present disclosure.

FIG. 3 is a flow diagram illustrating an algorithm for proving a user is physically in a particular location according to the present disclosure.

FIG. 4 is an illustrative view of the operations controlled by the algorithm in FIG. 3 according to the present disclosure

FIGS. 5-8 are exemplary user interface displays generated during execution of the algorithm in FIG. 3.

FIG. 9 is a block diagram detailing the hardware components of an apparatus that executes the algorithm according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

Hybrid work situations have been common place in a distributed workforce where some individuals are located at a first location such as an office conference room and one or more users are located remotely from the first location. In order to collaborate between various people located in different locales, an online collaboration system that works as, or in conjunction with, an online meeting application where people at the different locations can actively communicate with one another. In one exemplary type of online collaboration application, users at a first location such as the office can initiate the online collaboration between them and other members of the team that are not present in the office at the location. In so doing, the users at the first location, also termed the “in-person meeting attendees”, are able to share visual images of the a location that they are in. A problem exists when one or more areas in the first location are equipped to allow for visual communication such as this. For example, the first location may include a plurality of rooms each with an image capture apparatus that may be used to capture and transmit images of the particular room in which the image capture apparatus positioned. In a case where multiple rooms each including an image capture apparatus are present at a first location, it is important to ensure that whenever a collaboration session is established between in-person attendees and remote attendees, that images captured at the first location and transmitted to the remote attendees are the correct images. As such, a security measure is provided according to the present disclosure where, prior to starting a collaboration session using a meeting application, a mechanism provided for detecting and proving that a user is in the particular room at the first location and then associating the image capture apparatus with the meeting application for a duration of the meeting. This is particularly important when the manner for initiating an online meeting is performed using a universal resource locator or other web-based access. This is particularly problematic because any user with a device capable of accessing a network could begin a meeting in a room that they are not physically in at the time the meeting was started resulting in potential unauthorized access to information. Therefore, the present disclosure provides a presence detection algorithm that advantageously makes use of the in-room image capture apparatus. The presence detection algorithm controls the image capture apparatus in a room to capture an image of one or more users in a particular room and determines if a particular gesture is being made by one of the users. Once the correct gesture is detected, the presence detection algorithm advantageously notifies a control application, such as the meeting application, that a user is in fact in the room and associates the camera that has captured the image with a meeting room instance thereby allowing collaboration session to be initiated. In other words, the presence detection algorithm advantageously detects a user in a room and provides them with a user interface that enables the user to initiate an online collaboration session and share a series of images being captured by the image capture apparatus with any remote users who are invited to the collaboration session. The presence detection algorithm along with exemplary environments in which it operates will be described hereinbelow.

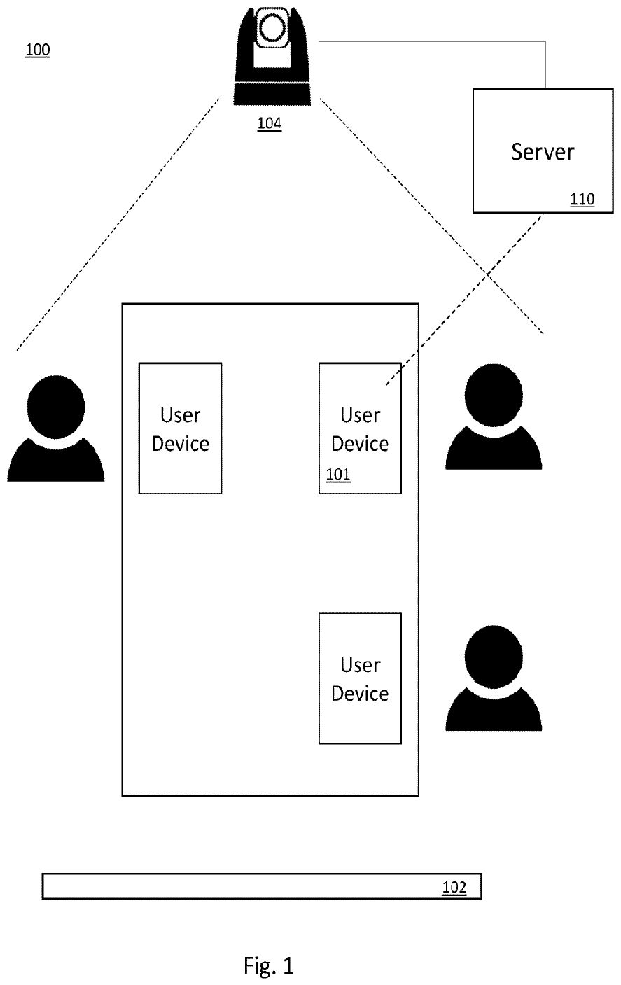

FIG. 1 illustrates a particular room 100 at a first location such as a conference or meeting room. The room 100 includes a meeting space whereby one or more users can join together and meet. As shown herein, the room includes a table or other surface and three users are illustrated around the table in room 100. The room 100 further includes a collaboration surface 102. In one embodiment, the collaboration surface is a whiteboard on which one or more users can write and erase text or draw pictures thereon. In another embodiment, the collaboration surface is a board to which object, paper and the like are able to be pinned and secure so that they are in full view of all users in the room. Thus, the collaboration surface 102 is any surface on which information or objects can be written or otherwise displayed and are in full view of the users present in room 100. The room 100 further includes one or more image capture apparatuses 104 that are configured to capture still image or video image data of the room. The image capture apparatus 104 shown has a field of view defined by the dashed lines in FIG. 1 and is able to capture images of all of the users and the collaboration surface 102 in the room 100. In one embodiment, the image capture apparatus is a pan, tilt zoom (PTZ) camera that is selectively controllable to perform pan, tilting and zoom functionality in order to capture the desired information. While FIG. 1 illustrates a single image capture apparatus 104, it should be understood that any number of image capture apparatuses 104 may be present in the room depending on how the room is set up.

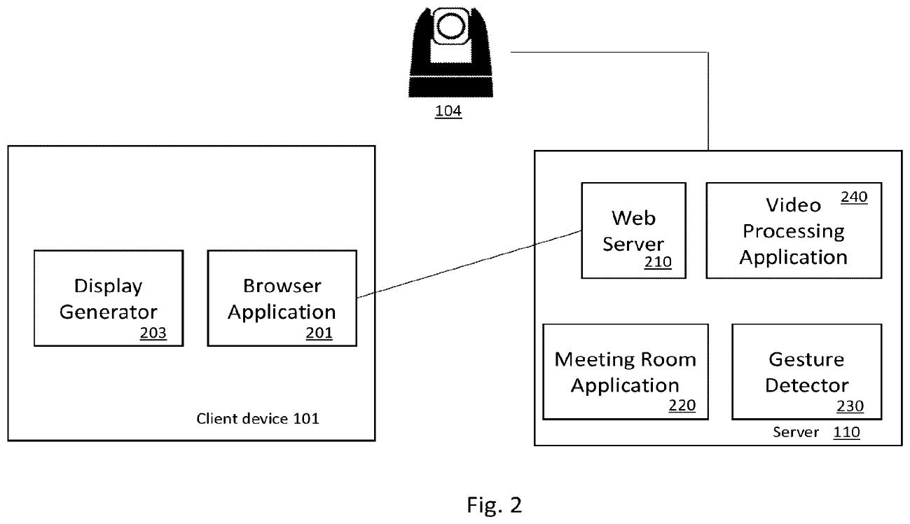

As noted, often times, collaboration or meetings require participants that are not in the room to participate in discussions. The drawback is that the remote participants do not have a full view of everything in the room. A meeting room application as described below is provided and selectively controls the camera to obtain a series of images (either a series of still images or video image data) from which different views of the room can be presented to the remote user via a user interface. The meeting room application described in greater detail with respect to FIG. 2 is executing on server 110. The meeting room application executing on server 110 is accessed by a user in the room via the user's device 101 such as a laptop, tablet, smartphone or any computing device that can communicate over a communication network such as a LAN and can display one or more user interfaces generated by the meeting room application so that the user can interact with the meeting room application and initiate a meeting between the in-room participates and one or more remote users. The connection between a user device and the server 110 is shown herein via a dotted line and, for example, is a wireless connection. However, this is shown for purposes of example only and any type of bidirectional communication between the device and server 110 is contemplated. The server 110 is illustrated as being in the room 100 such that an instance of the meeting room application is running as a local server. However, this is for purposes of example only and the server 110 may be in the cloud or remotely located from the room 100 so long as a user's device can access the server 110 from within the room.

Because there is a desire to maintain security so that any information in the room 100 is not improperly shared with persons (or users) outside the room, it is necessary to ensure that only a user in the room is able to access the meeting room application executing on the server 100 to start the meeting and visually share information in the room 100 such as on the collaboration surface. Furthermore, since the meeting room application is network accessible by any computing device, the presence detection algorithm as described below advantageously ensures that the meeting room application user interface which allows for starting, controlling and ending an online meeting or collaboration session is presented in the specific room where the user is detected and thus links an instance of the meeting room application to the room 100 and the imager capture apparatus 104 in that same room.

FIG. 2 is a block diagram illustrating the devices on which various applications used in implementing the presence detection algorithm and online meeting application according to the present disclosure. These hardware components are particularly programmed with specific applications that control the respective hardware components to operate in a particular manner. The system components that enable the execution of the presence detection algorithm include a client device 101, a server 110 and one or more image capture apparatuses 104. The client device 101 may be any computing device including, but not limited to, a laptop computer, a desktop computer, a tablet computing device and/or a smartphone. While each of these hardware devices includes various hardware components and software applications that control the operation of the respective devices, for purposes of ease of understanding the operation according to the present disclosure, only the select applications that are used as part of the presence detection algorithm or the implementation thereof will be described. It should be understood that each application, generator and detector described herein include instructions that are stored and are executed by one or more processors which configured the hardware processors to perform the operations described therein. In some embodiments, the components described herein maybe be implemented on an application specific integrated circuit (ASIC) that is specifically programmed to perform specific operations and interact with other system components.

The client device 101 includes a browser application 201 and a display generator 203. The browser application 201 may be any web browser such as, but not limited to GOOGLE CHROME, FIREFOX, MICROSOFT EDGE or the like. The browser application 201 interfaces with communication circuits of the client device such as network interfaces to bidirectionally communicate with other devices. In the present disclosure, the user of the client device can enter a web address in the browser application 201 which communicates the access request to the server 110 as will be discussed below. The client device 101 further includes a display generator which is configured to cause a display screen on the client device to display one or more user interfaces that allow users to interact with the client device. As used herein, the display generator 203 operates in conjunction with the browser application 201 which provides information to the display generator 203 to generate one or more user interfaces viewable on a display. In certain embodiments, the display of the client device 101 is a touch sensitive display and the inputs provided via touch input operations on the display can be used by the display generator to select user selectable image elements that the browser application 201 may cause the display generator 203 to display. In certain embodiments, the display generator 203 is a graphical processing unit (GPU).

The server 110 includes a web server 210 that bidirectionally communicates with the browser application 210 on the client device. The web server 210 enables secure access between the client device 101 and server 110 in a known manner. The server 110 also hosts a video processing application 240. The video processing application 240 is communicatively connected to the image capture apparatus 104. In one embodiment, the image capture apparatus is a PTZ camera and is connected to the server 240 via an internet protocol address which allows for images being captured to be provided as inputs to the video processing application 240 for further processing thereof. The video processing application 240 is able to create virtual cameras so that a plurality of portions of each frame of the image being captured can be segmented and provided an individual output. In this manner, the video processing application 240 creates multiple streams of image data originating from a single image frame. In one embodiment, the video processing application 240 performs these operation on sequentially received individual image frames whereby the video data captured by the image capture apparatus 104 processed on a frame by frame basis. In other embodiments, the video processing application 240 can use video data in a similar manner. The ability to divide and segment the received images captured by the image capture apparatus 104 is controlled in response to control commands from other applications executing on the server 110 such as the gesture detector 230 and the meeting room application 220.

The gesture detector 230 executes a gesture detection algorithm on image data captured by the image capture apparatus 104 and received by the video processing application 240. In response to a control command as will be described below, the gesture detector 230 receives, output from the video processing application 240 of a series of image frames representing the entire field of view captured by the image capture apparatus 104. On these frames the gesture detector 230 performs object and person detection algorithms to identify the users within the captured field of view and determine if one of the users in the captured field of view is performing a predetermined gesture. The gesture detector 230 compares successive frames and the movements of the users in the frame. Upon making a determination that the correct gesture has been made, the gesture detector 230 issues a message indicating the correct gesture has been detected. In one embodiment, the predetermined gesture is an extension of the hand and arm above the height of the head along with movement of the hand and arm in a predetermined plain. In this embodiment, the gesture detector 230 identifies a head region of the user in the frame and an arm and hand region. In other embodiments, to improve the gesture detection and avoid false positives the predetermined gesture may be a compound gesture comprised of multiple hand and arm positions and movements.

The meeting application 240 is an application that, when executed, coordinates an online collaboration session between the one or more users in the room at the first location and one or more remote users who are not presently located in the room. The meeting room application 240 generates and communicates a user interface via the web server 210 to the browser application 201 on the client device 101. The meeting room application 240 obtains, from the video processing application 240, the image data captured by the image capture apparatus 104 and provides the captured images to the generated user interface which is selectively viewable within the browser 201 of the client device 101. The meeting room user interface enables receipt of various inputs from the user via the client device. In one example, the meeting room user interface can display the field of view currently being captures and allows the user to define one or more regions of interest from within the field of view. In one example, the region of interest may be defined by selecting a predetermined number of single points within a frame. The selected points and coordinates within the frame are communicated back to the meeting room application 220 which uses them to segment out the around within the selected points within the frame. The meeting room application 220 causes the video processing application 240 to generate a virtual camera identifier associated with the selected region of interest. This region of interest is linked to the virtual camera identifier and is then provided as an option for display within a user interface that is viewable by the remote participants. For example, with respect to FIG. 1, the meeting room user interface receives inputs defining a boundary of a collaboration surface 102 (e.g. whiteboard). The meeting room application 220 receives the position information defined by the user and controls the video processing application 240 to create a virtual camera identifier corresponding the collaboration surface 102. The meeting room application 220 stores a list of virtual camera identifiers and their labels and makes them available to remote users in the form of user selectable image elements. During the collaboration session, the meeting room application 220 generates a second different user interface provided to the remote users which has a predefined format which allows the remote users to selectively control the images shown in the remote user interface by selecting and moving the available images into different positions within the remote user interface. This is enabled by the meeting room application 220 defining a set of virtual camera identifiers and each remote user can choose the image data to be shown at a given time by selecting image elements corresponding to virtual camera identifiers.

In addition to regions of interest defined by a user, the meeting room application 220 can automatically define additional regions of interest that can be assigned virtual camera identifiers. In one embodiment, a person detection algorithm configured to parse the image frame for a group of pixels that correspond to a person, is able to selectively define a region of interest incorporating that identified person. In this instance, each person identified is assigned a virtual camera identifier and can be provided as a viewable option in the remote user interface. In other embodiments, the gesture detector 230 can continually monitor the capture image data to determine if certain selection gestures are performed by a user within the frame. The selection gestures are different than the predetermined gesture described above used to prove the presence of a user in the room. Upon recognizing one or more selection gestures in the captured image data, the meeting room application 220 expands a pixel boundary a predetermined number of pixels in both the X and Y direction and defines that area as a region of interest and assigns a virtual camera identifier to that selected region.

It should be understood that video processing application 240, gesture detector 230 and meeting room application 220 are described as separate component algorithms for explanation purposes only. Each of these may be combined together into a single application or run as subroutines of a control application. Moreover, these components interact with one another on continuing basis in order to detect that a person is physically present in a room prior to that person being provided the meeting room user interface which initiates a collaboration session between users at the first location and one or more remote users.

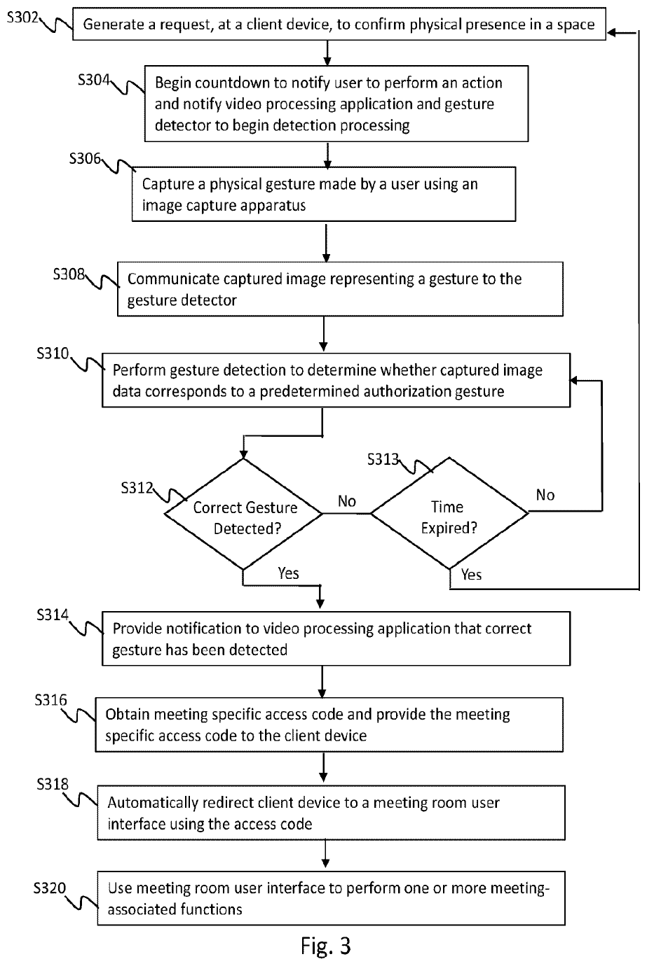

An exemplary presence detection algorithm will now be described with respect to FIGS. 3-8. The presence detection algorithm includes a set of executable instructions stored in a memory that are executed by one or more processing units or processors. In some instances the algorithm may be implemented as a system on a chip. The set of instructions, when executed, call function of various hardware components to perform the described functionality.

As discussed above, the presence detection algorithm advantageously identifies that a user is in a particular meeting room or collaboration space prior to providing, to that user, any mechanism for beginning an online collaboration session or online meeting between that user in the particular physical space and any other users not currently present in that physical space. This advantageously avoids the inadvertent sharing of any information or other goings on in the particular space. Moreover, the presence detection algorithm ensures that someone remotely located from that physical space cannot merely attempt to start a meeting when the meeting start mechanism is network-based and accessible via a web page.

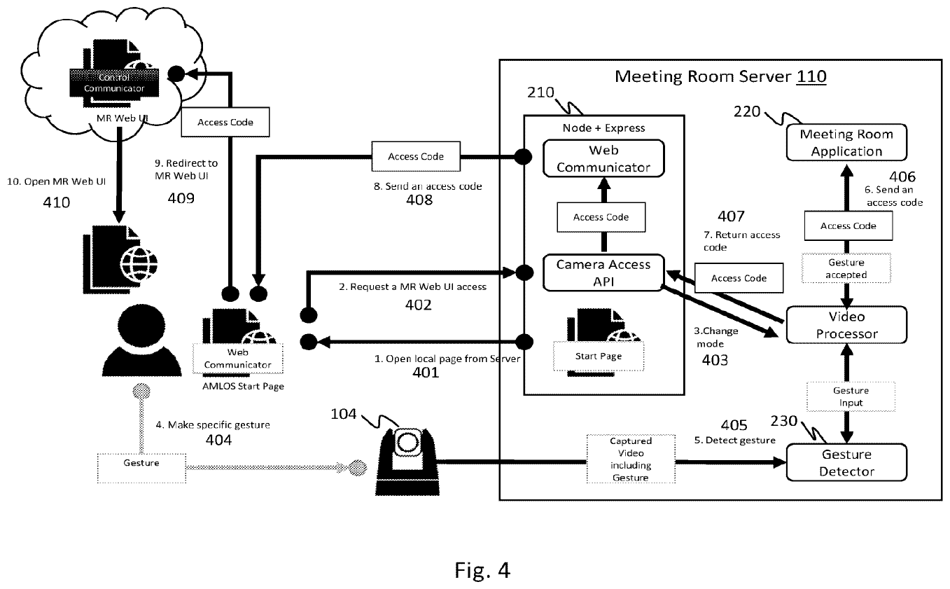

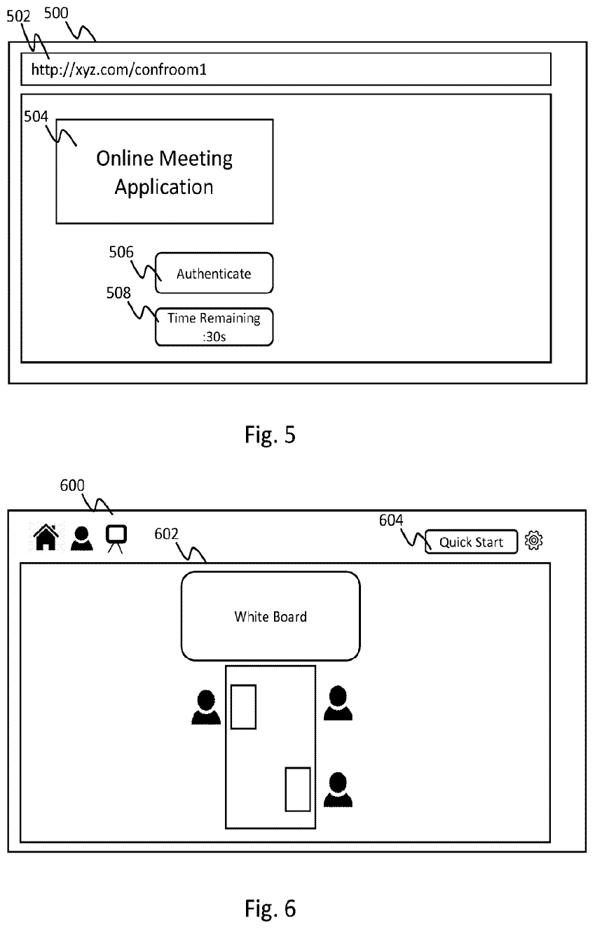

In step S302, when a user in a first location such as shown in FIG. 1 wishes to begin a meeting, the user generates a request, via a client device (e.g. laptop or other computing device) to confirm that the user is physically present in the first location. S302 is shown in FIG. 1 where by the user, in 401 uses a computing device with the browser application to access the server 110 at a predetermined internet protocol address. The web server communicates a first user interface representing a start page that provides one or more user selectable image elements that enable the user to request provision of a meeting room user interface for starting a collaboration session. This first user interface 500 representing a start page is illustrated in FIG. 5. In FIG. 5, the first user interface 500 includes an address bar 502 that presents a user fillable field where the IP address for server 110 is entered. In other embodiments, instead of a fillable address bar, the first user interface 500 may include a user selectable image element that has a pre-stored address associated therewith that, when selected via user input, sends the request to the server for the start page to be communicated to the user device. FIG. 5 also shows a title card 504 that identifies a name of the collaboration application. The first user interface 500 includes an authentication button 506 which is a user selectable image element that can be selected by the user and which generates a request as shown in 402 in FIG. 4 for a meeting room user interface and thus kicks off the presence detection algorithm. Further, the first user interface 500 includes a time region 508 that provides the user with a notification of an amount of time counting down that indicates the remaining amount of time for the user to perform the predetermined action as described herein.

In step S304, the web server of the server 110 receives the request and controls the server to begin a countdown requiring that a user perform a predetermined action (e.g. gesture) within a specific time frame. S304 further controls the video processing application 240 and gesture detector 230 to begin gesture detection processing on images being captured by the image capture apparatus 104. The countdown processing is also illustrated in the first user interface 500 which depicts a “time remaining” region 508 that is controlled by the countdown processing. This notifies the user that the predetermined action needs to be performed within the specified time frame. In one embodiment, the predetermined action is a physical gesture performed by one of the users in the physical space. FIG. 4 illustrates the receipt of the request for the meeting room user interface is received at a camera access API which generates a change mode message 403 that controls the mode operation of the video processing application 240 and the gesture detector 230. The information in the change mode signal causes the video processing application to begin capturing via of the first location and provide the captured video to the gesture detector 230 which performs gesture detection processing thereon.

In step S306, the image capture apparatus 104 is controlled to capture images of the first location within a predetermined field of view. These captures images include a user in the first location making or otherwise performing a predetermined gesture as shown in 404 in FIG. 4. The image capture apparatus 104 is controlled, by the video processing application 240, to capture images and provide those captured images, in S308, to the gesture detector 230. The gesture detector 230 in S310 performs the gesture detection processing whereby information in the captured images are compared to a predetermined gesture list to determine, in step S312, if the action being captured matches an authorization gesture. This is shown in 405 in FIG. 4 whereby images captured by the image capture apparatus 104 are fed as inputs to the gesture detector 230. The gesture detector 230, in S312, continually analyzes the successive image frames captured by the image capture apparatus to determine if one of the frames (or a series of frames, in the case where the gesture requires movement of a particular body part in a predetermined motion such as waiving a hand), to query whether the correct gesture is made. In exemplary operation, the gesture detector 230 analyzes the frame to identify movement within the frame. This advantageously narrows down the amount of area in the frame on which actual determination as to the correct gesture is being made. Upon identifying one or more objects in the frame that are moving, the gesture detector 230 creates a bounding box around the moving object and tracks the object in motion. In one embodiment, the movement analysis analyzes the frame to detect entire bodies moving in the frame. In another embodiment, the movement analysis is performed to identify objects likely to be human appendages (e.g. arms, hands, heads) that are moving. In another embodiment, a narrowing analysis is performed whereby the larger movement of a body is identified and thereafter areas around the detected body or areas within the bounding box are analyzed for arm and hand movements. In exemplary operation, the predetermined gesture to be recognized includes raising an arm and hand above a user's head and moving the arm and hand in a lateral manner (e.g., side to side). In this operation, the gesture detector detects the user moving and forms a bounding box around either the user entirely or just around the portion of the user moving (e.g. arm and hand). The gesture detector 230 compares the detected portion of the user and the associated movement to compare it to the predetermine gesture indicative of a user being present in the room.

In the case where the gesture detector 230 does not detect the correct gesture, a determination is made as to whether or not the countdown time initiated in S304 has expired as in S313. If the time has not yet expired then gesture detection processing in S310 is performed. If the determination in S313 indicates that time has expired, the processing returns to S302 which, in one embodiment, the user begins the authentication process again. In another embodiment, if the determination in S313 indicates that the time has expired, the processing reverts back to S304 whereby countdown processing begins again automatically. This loop may occur for a predetermined number of times so that the system is not indefinitely checking for gestures. After the expiration of the predetermined number of times, the authentication process resets and, to begin again, generate a request as in in S302. In another embodiment, if in S313, it is determined that time has expired, a notification indicating the expiration of time can be provided from the video processing application 240 via the camera access API and communicated via the web server for display in the first user interface.

Returning back to S312, when it is determined that a correct gesture has been made by the user and is successfully recognized by the gesture detector 230, a notification message is communicated by the gesture detector 230 to the video processing application 240 indicating that a correct gesture has been detected thereby proving that the user requesting the meeting room user interface is actually in the room for which the request has been made.

In step S316, in response to receipt of the message indicating the correct gesture has been detected, the video processing application 240 obtains, from the meeting room application 220, a meeting-specific access code that will be used to redirect the browser application on the client device to a location where the meeting room user interface can be accessed. The processing in step S316 is illustrated in 406 whereby the video processing application 240 indicates the success of the gesture detection and obtains an access code for the meeting. The obtained access code is provided from the video processing application 240 to the camera access API in 407 in FIG. 4 via a predetermined communication port and transmitted to the client device in 408 in FIG. 4. In step S318, the client device browser application is automatically redirected to the meeting room user interface provided by the meeting room application 220. In operation, the web server of meeting server 110 will communicate with the start page application which generated the first user interface in FIG. 5. The start page application will use the access code to redirect the client device to the meeting room user interface which is displayed within the browser of the client device. This is shown in 409 in FIG. 4 whereby the access code, which is meeting-specific, is used to redirect the browser on the client device to display a second user interface representing the meeting room user interface. Once displayed, a user may perform one or more meeting-associated functions in S320 such as initiate a collaboration session or meeting, define regions of interest that will be shared during the collaboration session or meeting and the like.

An example of the second user interface 600 representing the meeting room user interface is shown in FIG. 6. The meeting room user interface 600 includes a first region 602 that displays, in real time, the images being captured by the image capture apparatus 104. For example, the first region 602 displays an image similar to the one shown in FIG. 1. The video processing application 240 controls the image capture device to capture and stream real-time images of the entire field of view of the first location. As can be seen in FIG. 6, the field of view of the image capture apparatus 104 captures all of the users in the first location as well as the collaboration surface (e.g. the whiteboard whereby users can physically write information thereon). While a single whiteboard is shown, it is for purposes of example and there may be a plurality of collaboration surfaces, each of a different type, that are present in the current field of view of the image capture apparatus. Additionally a plurality of user selectable image elements are shown that receive user inputs and perform one or more meeting associated functions. In one embodiment, a meeting associated function includes defining a region of interest that the video processing application 240 will crop and associate with a virtual camera identifier so that the information in the defined region of interest can be communicated to a remote user interface during an online meeting or collaboration session. In another embodiment, a meeting-associated function includes identifying one of the users in the room as a presenter. In exemplary operation, at least one of the users is recognized via facial recognition and the user can select one of the identified individuals as a presenter. This selection cause the video processing application to associate the identified presenter with a virtual camera identifier which can also be made available for selection and display in a remote user interface during an online meeting or collaboration session. In another exemplary operation, the users captured may be uniquely identified using a person and/or face detection processing that detects the presence of the face of a user which can be uniquely identified with different generic identifiers such as “user 1”, “user 2”, etc. These generic identifiers can later be relabeled with personal identifiers such as the user's name using a function provided by the meeting room application.

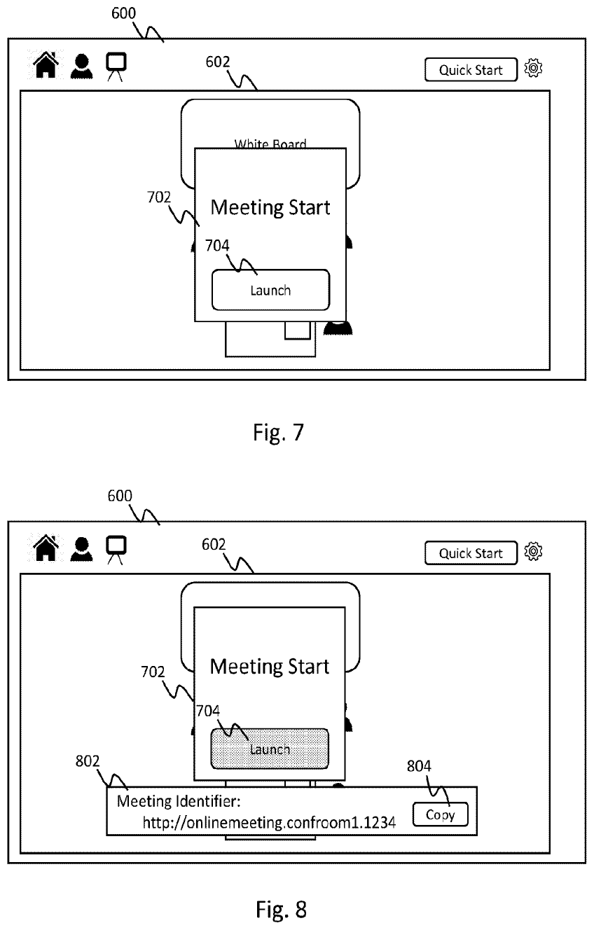

The meeting room user interface 600 of FIG. 6 further includes a “quick start” image element 604 that, when selected by a user within the browser, generates a request to initiate an online collaboration session which, when received by the meeting room application 220 generates a unique meeting identifier in the form of a URL that can be copied and transmitted to other users to join the online collaboration session. These user interfaces are shown in FIG. 7 and FIG. 8. FIG. 7 includes an updated second user interface 600 which includes an overlay image element 702 in the first region 602 on the meeting room user interface 600. The overlay image element includes a selection region 704 that enables receipt of a selection from the user to launch a meeting. FIG. 8 illustrates a further updated second user interface 600 wherein a second overlay image element 802 is provided within the first region 602. The second overlay image element 802 includes the unique meeting identifier and a copy function 804 that allows the user to copy the unique meeting identifier to memory so that it can be provided to other users. In one embodiment, this may include copying and pasting of the identifier in an electronic mail message. In another embodiment, this may include copying and pasting of the identifier into a chat application where one or more users that are in the first location and within the field of view captured by the image capture apparatus and users who are remote from the first location may receive the unique meeting identifier. Upon selection of the unique meeting identifier, a remote user interface (not shown) is generated and allows for those users to selectively display any information associated with any virtual camera identifier therein in a predetermined display format.

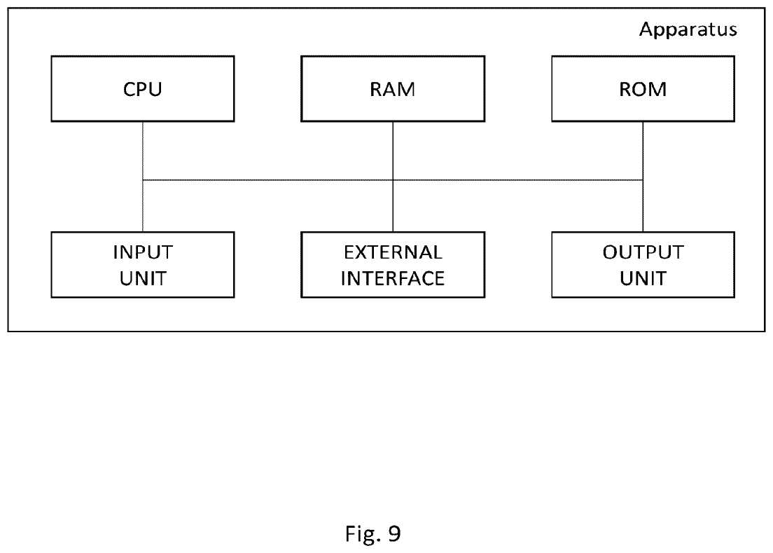

FIG. 9 illustrates the hardware that represents any of the server, the cloud service and/or client device that can be used in implementing the above described disclosure. The apparatus includes a CPU, a RAM, a ROM, an input unit, an external interface, and an output unit. The CPU controls the apparatus by using a computer program (one or more series of stored instructions executable by the CPU) and data stored in the RAM or ROM. Here, the apparatus may include one or more dedicated hardware or a graphics processing unit (GPU), which is different from the CPU, and the GPU or the dedicated hardware may perform a part of the processes by the CPU. As an example of the dedicated hardware, there are an application specific integrated circuit (ASIC), a field-programmable gate array (FPGA), and a digital signal processor (DSP), and the like. The RAM temporarily stores the computer program or data read from the ROM, data supplied from outside via the external interface, and the like. The ROM stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any disclosure derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A server comprising:
one or more processors; and
one or more memories storing instructions that, when executed, configures the one or more processors, to:
receive a series of images including at least one user captured by an image capture apparatus;
provide a user interface that enables initiation of an online meeting in response to detecting, in the received series of images, that one of the at least one users has performed a predetermined gesture indicative of the user being physically present in a particular space.

2. The server according to claim 1, wherein execution of the stored instructions further configures the one or more processors to:
receive a request, from a client device, to initiate a presence detection processing;
initiate a countdown time for analyzing the received series of images;
in response to determining that a predetermined physical gesture has been performed prior to the countdown expiring, generate a message indicating physical presence is detected.

3. The server according to claim 1, wherein execution of the stored instructions further configures the one or more processors to:
determine if the received series of images includes a user performing the predetermined gesture; and
notify a video processing application that the predetermined gesture is present in the received series of images.

4. The server according to claim 1, wherein execution of the stored instructions further configures the one or more processors to:
obtain, in response to determining that the predetermined gesture has been performed, a meeting specific access code; and
provide the obtained meeting specific access to a client device in communication with the server.

5. The server according to claim 4, wherein execution of the stored instructions further configures the one or more processors to:
automatically redirect the client device to a meeting room user interface that enables control of an online meeting.

6. A method comprising:
receiving, from an image capture device, a series of images including at least one user captured by an image capture apparatus; and
providing a user interface that enables initiation of an online meeting in response to detecting, in the received series of images, that one of the at least one users has performed a predetermined gesture indicative of the user being physically present in a particular space.

7. The method according to claim 6, further comprising:
receiving a request, from a client device, to initiate a presence detection processing;
initiating a countdown time for analyzing the received series of images; and
in response to determining that a predetermined physical gesture has been performed prior to the countdown expiring, generating a message indicating physical presence is detected.

8. The method according to claim 7, further comprising:
determine if the received series of images includes a user performing the predetermined gesture; and
notify a video processing application that the predetermined gesture is present in the received series of images.

9. The method according to claim 7, further comprising:
obtaining, in response to determining that the predetermined gesture has been performed, a meeting specific access code; and
providing the obtained meeting specific access to a client device in communication with the server.

10. The method according to claim 9, further comprising:
automatically redirecting the client device to a meeting room user interface that enables control of an online meeting.

11. A client device that is configured to communicate with a server configured to control an online meeting between users present in a physical space and at least one remote user, the client device comprising:
a display;
one or more memories storing instructions; and
one or more processors that, upon execution of the stored instructions, are configured to:
display, on the display, a user interface enabling a user of the client device to initiate an online meeting controlled by the server; and
automatically redirect the client device to the server controlling an online meeting when the server determines that the user in the physical space and who initiated the online meeting has performed a predetermined physical gesture.

12. The client device according to claim 11, wherein execution of the stored instructions further configures the one or more processors to:
generate a user interface displayed on the display including a meeting identifier specific to the meeting initiated in the physical space; and
enable the user of the client device to provide the meeting identifier to one or more remote users allowing the one or more remote users to join the online meeting.

13. A method performed by a client device that is configured to communicate with a server configured to control an online meeting between users present in a physical space and at least one remote user, the method comprising:
displaying, on a display, a user interface enabling a user of the client device to initiate an online meeting controlled by the server; and
automatically redirecting the client device to the server controlling an online meeting when the server determines that the user in the physical space and who initiated the online meeting has performed a predetermined physical gesture.
